(19) United States
(12) Patent Application Publication
(10) Pub. No.: US 2025/0371915 A1
(43) Pub. Date: Dec. 4, 2025

(54) IN-VEHICLE DEVICE

(71) Applicant: TOYOTA JIDOSHA KABUSHIKI KAISHA, Toyota-shi (JP)

(72) Inventor: Takeru KANEKO, Seto-shi (JP)

(73) Assignee: TOYOTA JIDOSHA KABUSHIKI KAISHA, Toyota-shi (JP)

(21) Appl. No.: 19/026,578

(22) Filed: Jan. 17, 2025

(30) Foreign Application Priority Data
May 28, 2024 (JP) 2024-086401

(51) Int. Cl. G07C 5/00; G07C 5/08

(52) U.S. Cl. CPC G07C 5/008; G07C 5/0808

(57) ABSTRACT

The communication module performs a process of collecting vehicle information from a vehicle control ECU connected to the in-vehicle network and transmitting the vehicle information to the managing server. The communication module monitors a CAN signal transmitted over DLC. Monitoring module determines whether the diagnostic tool is connected via DLC based on the monitoring result of the CAN signal. The communication module includes the determination result of the connection determination in the vehicle information and transmits the vehicle information to the management server.

### CROSS-REFERENCE TO RELATED APPLICATION

This application claims priority to Japanese Patent Application No. 2024-086401 filed on May 28, 2024, incorporated herein by reference in its entirety.

### BACKGROUND

### 1. Technical Field

The present disclosure relates to an in-vehicle device.

### 2. Description of Related Art

Conventionally, in an in-vehicle device mounted on a vehicle, there is a data communication module (DCM) that performs failure diagnosis communication with an electronic control unit (ECU) of the vehicle and transmits the result to a predetermined server. There is also known an external diagnostic tool that is connected via a data link connector (DLC) included in a vehicle and performs various diagnoses by performing failure diagnosis communication with an ECU of the vehicle.

Further, as in Japanese Unexamined Patent Application Publication No. 2014-78800 (JP 2014-78800 A), when a communication request is made to a central gateway of a vehicle from both a DCM and an external diagnostic tool, a response to the communication request from the external diagnostic tool is prioritized by stopping the communication request from the DCM.

### SUMMARY

As described above, when the external diagnostic tool is connected via the DLC, the DCM may not be able to appropriately collect information on the vehicle, since the response to the communication request from the external diagnostic tool is prioritized. In this case, the server may not be able to provide an appropriate service.

In order to address the above issue, an aspect provides
an in-vehicle device that is mounted to an in-vehicle network and performs a process of collecting vehicle information from each device connected to the in-vehicle network and transmitting the vehicle information to a server, including
a processing circuit configured to: monitor a control area network (CAN) signal transmitted via a connector for external connection mounted to the in-vehicle network;
perform a connection determination as to whether a predetermined communication device is connected to the in-vehicle network via the connector based on a result of the monitoring of the CAN signal; and
transmit a determination result of the connection determination as included in the vehicle information to the server.

According to the above configuration, it is possible to suppress the server being unable to provide an appropriate service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a vehicle, a diagnostic tool, and an external management server;

FIG. 2 is a diagram illustrating a relationship between a communication request and a communication response from a communication module and a diagnostic tool to a vehicle control ECU;

FIG. 3 is a diagram illustrating a flow of a communication process in an in-vehicle network; and

FIG. 4 is a diagram illustrating a flow of communication processing in an in-vehicle network.

### DETAILED DESCRIPTION OF EMBODIMENTS

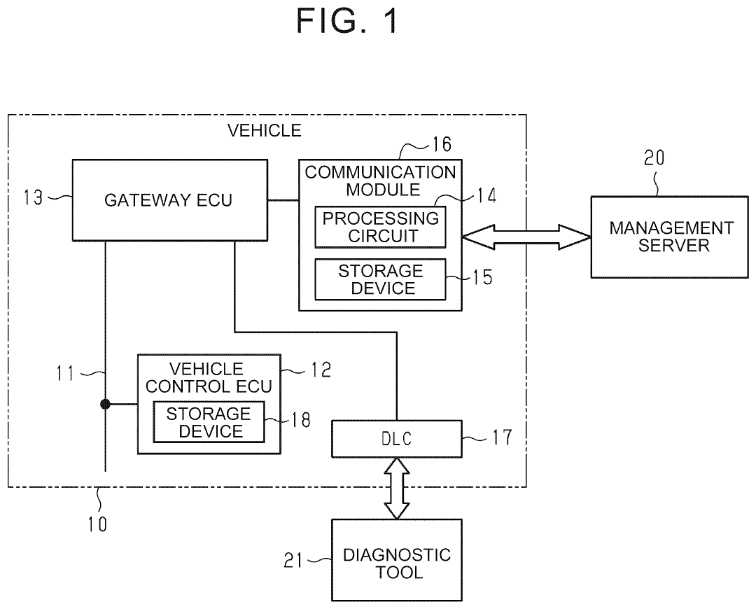

Hereinafter, an embodiment of an in-vehicle device mounted on an in-vehicle network will be described with reference to FIG. 1 to FIG. 4.

### Configuration of In-vehicle Network

First, with reference to FIG. 1, an in-vehicle network on which the in-vehicle device of the present embodiment is mounted will be described.

The vehicle 10 includes an in-vehicle network 11. Various electronic control units for vehicle control are installed in the in-vehicle network 11. Examples of the electronic control unit for vehicle control include an electronic control unit for engine control, an electronic control unit for brake control, and an electronic control unit for shift control. In the following explanation, such an electronic control unit for vehicle control is referred to as a vehicle control ECU 12. FIG. 1 shows only one of a plurality of vehicle control ECU 12 mounted on a vehicle 10. The vehicle control ECU 12 has a self-diagnosis function. The vehicle control ECU 12 includes a storage device 18 for recording diagnostic data that is data used for diagnosing the vehicle 10. The diagnosis data includes the self-diagnosis of the vehicle control ECU 12 and various kinds of data indicating the operation status of the vehicle 10.

A gateway ECU 13, which is an electronic control unit for managing communication, is installed in the in-vehicle network 11. The gateway ECU 13 includes a memory for storing a communication managing program and data, and a processing circuit for executing a program read from the memory.

A communication module 16 for wirelessly connecting to a wireless LAN and a mobile communication network is connected to the gateway ECU 13. The communication module 16 is an example of an in-vehicle device mounted on the in-vehicle network 11. The communication module 16 includes a processing circuit 14 for executing various kinds of control, and a storage device 15 for storing various kinds of information. The communication module 16 enables radio communication between the gateway ECU 13 and the management server 20 outside the vehicle. The processing circuit 14 of the communication module 16 can collect vehicle information including diagnosis data of the vehicle 10 from each device connected to the in-vehicle network 11 and transmit the collected vehicle information to the server. The storage device 15 of the communication module 16 stores vehicle information about the vehicle 10. The management server 20 is a server device for managing information of each vehicle 10 under management.

A DLC (data link connector) 17, which is a connector for external connection for wired connection with an external device, is connected to the gateway ECU 13. In a dealer or the like, a diagnosis of the vehicle 10 is performed by connecting a diagnostic tool 21 outside the vehicle to a DLC 17. The diagnostic tool 21 has a function of reading data necessary for diagnosis of the vehicle 10 from the vehicle 10 and displaying the data. The diagnostic tool 21 is an exemplary communication device connected to the in-vehicle network 11 via a DLC 17.

### Communication in In-vehicle Network

The plurality of vehicle control ECU 12, the communication module 16, and the diagnostic tool 21 perform communication (hereinafter, referred to as CAN communication) conforming to the protocol of CAN (control area network) via the gateway ECU 13. The vehicle control ECU 12, the communication module 16, and the diagnostic tool 21 are examples of nodes connected to the in-vehicle network 11.

In CAN communication, communication is performed between the nodes connected to the in-vehicle network 11 by CAN communication. In CAN communication, a CAN signal is transmitted in a single group called a frame. The frame includes, for example, a data frame in which data designated by the user can be stored, and a remote frame for requesting a data frame.

In the data frame, for example, a ID area, a RTR (remote transmission request) area, a data field area, and the like are provided. ID area is an area in which the content of data and ID for identifying the node that transmitted the data frame are set. ID is an identifier for identifying a node that has transmitted the data frame. ID area is also an area for determining priorities of communication arbitration. The communication arbitration will be described in detail later. RTR area is an area for identifying a data frame and a remote frame. The data field area is an area including data to be transmitted.

The structure of the remote frame is the same as that of the data frame excluding the data field. That is, the remote frame is provided with, for example, a ID area, a RTR area, and the like, but is not provided with a data field area. In ID area of the remote frame, ID of the node that transmits the requested data frame is set.

In a CAN protocol-a node that requires data-requests communication by sending a remote frame to a gateway ECU 13. The remote frame transmitted to the gateway ECU 13 is transmitted to all the nodes connected to the in-vehicle network 11. The node having the data corresponding to the transmitted remote frame then responds to the communication by transmitting the data frame to the gateway ECU 13. The data frame transmitted to the gateway ECU 13 is transmitted to all the nodes connected to the in-vehicle network 11. Then, the node that needs the data acquires the necessary data by receiving the transmitted data frame.

### Communication Arbitration

In communication compliant with CAN, frames may be transmitted from a plurality of nodes at the same time. In such a case, a frame having a high priority is preferentially transmitted by performing communication arbitration. The priorities of the frames are determined by ID set in ID regions of the frames. Specifically, when a frame is simultaneously transmitted from a plurality of nodes, each node transmitting the frame monitors and compares the state of the communication bus with that transmitted by the node. At this time, the state of the bus coincides with a frame having a high priority. Then, each node continues transmission of the frame when the state of the bus matches the one transmitted by the node itself, and stops transmission of the frame when the state of the bus does not match the one transmitted by the node itself.

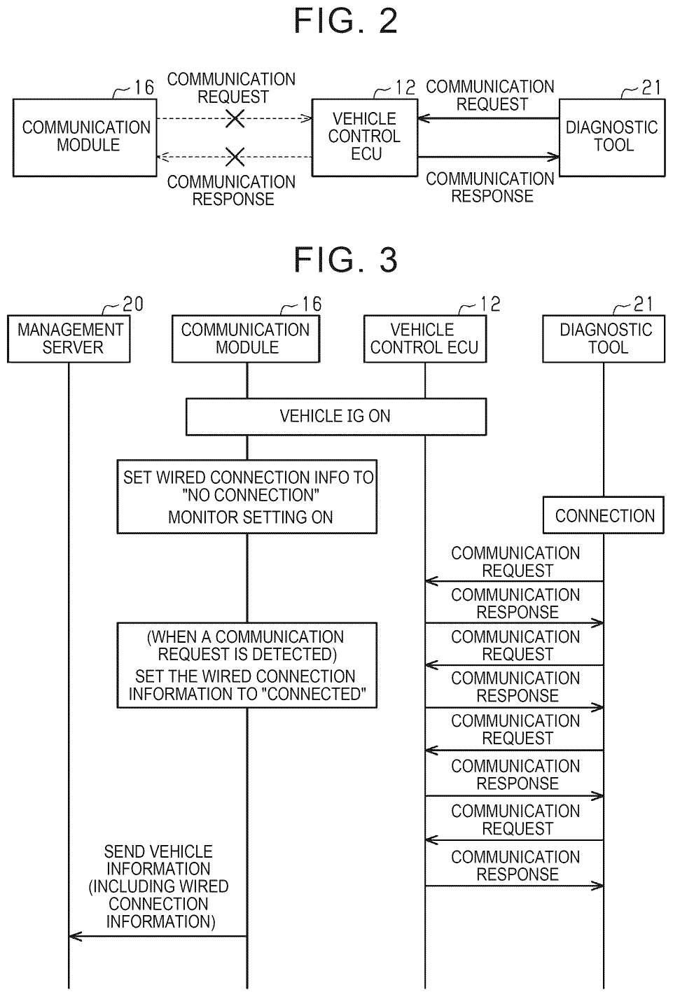

As illustrated in FIG. 2, in the present embodiment, ID is set in ID areas of the respective frames so that the frames transmitted from the diagnostic tool 21 have higher priorities than the frames transmitted from the communication module 16. For this reason, for example, it is assumed that the communication module 16 and the diagnostic tool 21 simultaneously start transmitting a remote frame requesting data to the vehicle control ECU 12. In this case, the transmission of the remote frame from the diagnostic tool 21 is continued, and the transmission of the remote frame from the communication module 16 is stopped. Therefore, the data frame corresponding to the remote frame transmitted from the diagnostic tool 21 is transmitted from the vehicle control ECU 12, while the data frame corresponding to the remote frame transmitted from the communication module 16 is not transmitted. That is, when the communication request from the communication module 16 and the communication request from the diagnostic tool 21 occur at the same time, as shown in FIG. 2, the communication request from the diagnostic tool 21 is prioritized, and the communication request from the communication module 16 is stopped. Therefore, the vehicle control ECU 12 transmits a communication response to the communication request from the diagnostic tool 21, and does not transmit a communication response to the communication request from the communication module 16.

### Diagnosis of Vehicle 10

The diagnostic tool 21 is capable of diagnosing the vehicle 10 by fault diagnosis communication via a DLC 17. Specifically, the diagnostic tool 21 transmits a remote frame requesting the transmission of the diagnostic data to the gateway ECU 13 via DLC 17, thereby making a communication request to the vehicle control ECU 12. The gateway ECU 13 transmits the remote frames transmitted from the diagnostic tool 21 to the respective nodes on the in-vehicle network 11. That is, the gateway ECU 13 transmits the remote frame transmitted from the diagnostic tool 21 to the vehicle control ECU 12, the communication module 16, and the diagnostic tool 21. Upon receiving the remote frame requesting the transmission of the diagnostic data, the vehicle control ECU 12 transmits the data frame including the diagnostic data to the gateway ECU 13, thereby making a communication reply to the diagnostic tool 21. The gateway ECU 13 transmits a data frame including the diagnostic data to the respective nodes on the in-vehicle network 11. That is, the gateway ECU 13 transmits the data frame including the diagnostic data to the vehicle control ECU 12, the communication module 16, and the diagnostic tool 21. When receiving the data frame including the diagnosis data, the diagnostic tool 21 performs diagnosis of the vehicle 10 using the diagnosis data. Note that the vehicle control ECU 12 may acquire the diagnostic data by performing communication between the plurality of vehicle control ECU 12 in response to the reception of the remote frame. When the ignition of the vehicle 10 is turned on, the vehicle control ECU 12 acquires the diagnosis data by performing communication between the plurality of vehicle control ECU 12 at any timing, and stores the diagnosis data in the storage device 18. Then, the vehicle control ECU 12 may acquire the diagnostic data from the storage device 18 in response to the reception of the remote frame.

In addition, the management server 20 can diagnose the vehicle 10 by failure diagnosis communication via the communication module 16. Specifically, the processing circuit 14 of the communication module 16 transmits a remote frame requesting the transmission of the diagnostic data to the gateway ECU 13, thereby making a communication request to the vehicle control ECU 12. The gateway ECU 13 transmits the remote frames transmitted from the communication module 16 to the respective nodes on the in-vehicle network 11. That is, the gateway ECU 13 transmits the remote frame transmitted from the communication module 16 to the vehicle control ECU 12, the communication module 16, and the diagnostic tool 21. Upon receiving the remote frame transmitted from the communication module 16, the vehicle control ECU 12 transmits a data frame including the diagnostic data to the gateway ECU 13 to respond to the communication module 16. The gateway ECU 13 transmits a data frame including the diagnostic data to the respective nodes on the in-vehicle network 11. That is, the gateway ECU 13 transmits the data frame including the diagnostic data to the vehicle control ECU 12, the communication module 16, and the diagnostic tool 21. The processing circuit 14 of the communication module 16 stores the diagnostic data included in the received data frame in the storage device 15. The diagnosis data is stored in the storage device 15 as vehicle information about the vehicle 10. Then, the processing circuit 14 of the communication module 16 transmits the vehicle information including the diagnosis data stored in the storage device 15 to the management server 20. For example, the processing circuit 14 of the communication module 16 transmits the vehicle information to the management server 20 at a predetermined cycle. The management server 20 diagnoses the vehicle 10 using the diagnosis data included in the received vehicle information.

### Transmission of Vehicle Information by Communication Module

Hereinafter, a specific control for the processing circuit 14 of the communication module 16 to transmit the vehicle information to the management server 20 will be described.

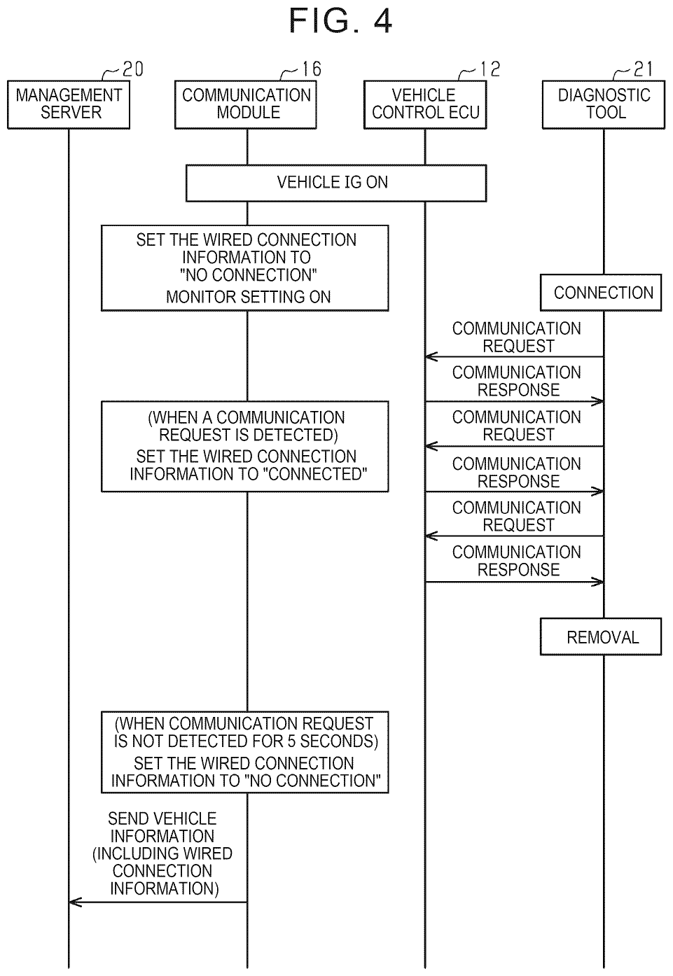

As illustrated in FIG. 3, when the ignition of the vehicle 10 is turned on, the processing circuit 14 of the communication module 16 sets the wired connection information stored in the storage device 15 to “no connection”. In FIGS. 3 and 4, the ignition is referred to as “IG”. The wired connection information is information for specifying whether or not the diagnostic tool 21 is connected via DLC 17. The wired connection information is stored in the storage device 15 as vehicle information about the vehicle 10. Further, the processing circuit 14 of the communication module 16 sets the monitor setting to ON to monitor whether the diagnostic tool 21 is connected via DLC 17 when the ignition of the vehicle 10 is turned on. The processing circuit 14 of the communication module 16 monitors CAN transmitted on the in-vehicle network 11 when the monitoring setting is set to ON.

The processing circuit 14 of the communication module 16 determines whether the diagnostic tool 21 is connected to the in-vehicle network 11 via DLC 17 based on CAN monitoring. Specifically, when connected to DLC 17, the diagnostic tool 21 transmits a remote frame requesting the transmission of the diagnostic data at a predetermined cycle via DLC 17, thereby making a communication request to the vehicle control ECU 12. In addition, the vehicle control ECU 12 transmits a data frame including the diagnostic data in response to reception of the remote frame transmitted from the diagnostic tool 21, thereby communicating with the diagnostic tool 21.

Here, the remote frame transmitted from the diagnostic tool 21 and the data frame transmitted from the vehicle control ECU 12 are also transmitted to the communication module 16 via the gateway ECU 13. Then, upon receiving the remote frame transmitted from the diagnostic tool 21, the processing circuit 14 of the communication module 16 sets the wired connection information to “connected”. At this time, when ID included in the received remote frame is ID indicating the diagnostic tool 21, the processing circuit 14 of the communication module 16 determines that the remote frame is a remote frame transmitted from the diagnostic tool 21. In other words, the processing circuit 14 of the communication module 16 determines that the diagnostic tool 21 is connected when a communication request from the diagnostic tool 21 is detected. That is, the processing circuit 14 of the communication module 16 determines that the diagnostic tool 21 is connected when ID indicating the diagnostic tool 21 is detected in the connection determination.

Thereafter, the processing circuit 14 of the communication module 16 transmits the vehicle information including the wired connection information to the management server 20 at a predetermined timing. That is, the processing circuit 14 of the communication module 16 transmits the vehicle information including the wired connection information indicating that the diagnostic tool 21 is connected to the management server 20.

Further, as illustrated in FIG. 4, the processing circuit 14 of the communication module 16 sets the wired connection information to “no connection” when a predetermined time elapses without receiving the remote frame transmitted from the diagnostic tool 21. In other words, the processing circuit 14 of the communication module 16 determines that the diagnostic tool 21 is not connected when a certain period of time has elapsed without detecting a communication request from the diagnostic tool 21. That is, the processing circuit 14 of the communication module 16 determines that the diagnostic tool 21 is not connected when ID indicating the diagnostic tool 21 is not detected for a certain period of time in the connection determination. In the present embodiment, the fixed time period is a time period longer than a time period from when the previous remote frame is transmitted until when the next remote frame is transmitted when the diagnostic tool 21 transmits the remote frame at a predetermined cycle.

As shown in FIG. 4, after that, when transmitting the vehicle information to the management server 20 at a predetermined timing, the processing circuit 14 of the communication module 16 transmits the vehicle information including the wired connection information in the vehicle information. That is, the processing circuit 14 of the communication module 16 transmits, to the management server 20, the vehicle information including the wired connection information of “no connection” indicating that the diagnostic tool 21 is not connected.

### Operations of Embodiment

According to the present embodiment, the communication module 16 can notify the management server 20 of the determination result of the connection determination as to whether the diagnostic tool 21 is connected by transmitting the vehicle information including the wired connection information to the management server 20. Here, the vehicle information may also include diagnosis data of the vehicle 10. Therefore, in the present embodiment, when the diagnosis data of the vehicle 10 is transmitted to the management server 20, the management server 20 can also be notified of the determination result of the connection determination as to whether the diagnostic tool 21 is connected.

In particular, the communication module 16 determines whether the diagnostic tool 21 is connected by monitoring whether CAN transmitted and received within the in-vehicle network 11 includes ID indicative of the diagnostic tool 21. That is, the communication module 16 determines whether the diagnostic tool 21 is connected based on CAN transmitted from the diagnostic tool 21.

The communication module 16 determines that the diagnostic tool 21 is not connected when CAN including ID indicating the diagnostic tool 21 is not detected for a certain period of time. In other words, the communication module 16 determines that the diagnostic tool 21 is connected for a certain period of time after the last detection of CAN including ID indicating the diagnostic tool 21.

In addition, in the exemplary embodiment of FIG. 3, the communication module 16 cannot make a communication request to the vehicle control ECU 12 through the communication arbitration while the communication request from the diagnostic tool 21 is being made. Therefore, the communication module 16 may not be able to receive a communication response corresponding to a communication request transmitted from the communication module 16 to the vehicle control ECU 12 while the diagnostic tool 21 is connected via DLC 17. Therefore, the communication module 16 may not be able to acquire the diagnosis data of the vehicle 10.

On the other hand, in the embodiment of FIG. 4, the communication module 16 may make a communication request to the vehicle control ECU 12 after the diagnostic tool 21 is removed. The communication module 16 receives a communication response corresponding to the communication request transmitted from the communication module 16 to the vehicle control ECU 12, thereby acquiring the diagnosis data of the vehicle 10.

Here, in the present embodiment, the communication module 16 transmits the vehicle information when transmitting the vehicle information to the management server 20, regardless of whether the diagnostic tool 21 is connected or not via DLC 17. The vehicle information includes wired connection information. That is, the communication module 16 includes the determination result of the connection determination as to whether the diagnostic tool 21 is connected, in the vehicle information, and transmits the determination result to the management server 20, whether the communication response from the vehicle control ECU 12 has been received or the communication response has not been received.

### Effects of Present Embodiment

The effects of the present embodiment will be described.
(1) When transmitting the information to the management server 20, the communication module 16 can also notify the management server 20 of the determination of whether or not the diagnostic tool 21 is connected via DLC 17. That is, it is possible to notify the management server 20 that the information of the vehicle 10 is not properly collected due to the connection of the diagnostic tool 21. Therefore, it is possible to issue a notification instructing execution of an appropriate action from the management server 20, or to stop providing a service based on insufficient information. As a result, it is possible to prevent the management server 20 from being unable to provide an appropriate service. In addition, it is possible to prevent the management server 20 from providing a low-quality service based on the half-way information.
(2) The communication module 16 can appropriately determine that the diagnostic tool 21 is connected in order to determine whether the diagnostic tool 21 is connected based on CAN transmitted from the diagnostic tool 21. According to this, it is possible to allow the management server 20 to appropriately recognize whether or not the diagnostic tool 21 is connected.
(3) Since the diagnostic tool 21 transmits CAN signal at a predetermined cycle, the time when CAN signal from the diagnostic tool 21 is transmitted and the time when it is not transmitted occur even when the diagnostic tool 21 is connected via DLC 17. On the other hand, the communication module 16 determines that the diagnostic tool 21 is connected for a certain period of time after the last detection of CAN including ID indicating the diagnostic tool 21. According to this configuration, when the diagnostic tool 21 is connected, the communication module 16 can prevent the management server 20 from being mistakenly recognized that the diagnostic tool 21 is not connected due to the fact that CAN from the diagnostic tool 21 is not temporarily transmitted.
(4) The communication module 16 includes the determination result of the connection determination as to whether the diagnostic tool 21 is connected, in the vehicle information, and transmits the determination result to the management server 20, whether the communication response from the vehicle control ECU 12 has been received or the communication response has not been received. According to this configuration, the management server 20 can recognize whether or not the diagnostic tool 21 is connected, regardless of whether or not the communication module 16 has received a communication reply from the vehicle control ECU 12. Therefore, it is possible to prevent an inability to provide an appropriate service.

### Modifications

The present embodiment can be realized with the following modifications. The present embodiment and the following modifications can be combined with each other within a technically consistent range to be realized.

In the connection determination by the processing circuit 14 of the communication module 16, the condition for determining that the diagnostic tool 21 is connected may be changed as appropriate. For example, the processing circuit 14 of the communication module 16 may determine that the diagnostic tool 21 is connected on condition that the communication request from the diagnostic tool 21 is detected a predetermined number of times within a predetermined period of time.

In the connection determination by the processing circuit 14 of the communication module 16, the condition for determining that the diagnostic tool 21 is not connected may be changed as appropriate. For example, the processing circuit 14 of the communication module 16 may determine that the diagnostic tool 21 is not connected when a communication request from the diagnostic tool 21 is not detected within a predetermined determination timing or determination period determined in advance.

When the vehicle information is transmitted from the communication module 16 to the management server 20, the wired connection information may not be included in the vehicle information. For example, the processing circuit 14 of the communication module 16 may include the wired connection information in the vehicle information to be transmitted to the management server 20 on condition that the communication response from the vehicle control ECU 12 could not be received. In other words, the processing circuit 14 of the communication module 16 may not include the wired connection information in the vehicle information to be transmitted to the management server 20 when the communication response from the vehicle control ECU 12 can be received.

The timing at which the communication module 16 makes a communication request to the vehicle control ECU 12 may be changed as appropriate. The timing at which the diagnostic tool 21 requests the vehicle control ECU 12 to communicate may be changed as appropriate.

The timing at which the communication module 16 transmits the vehicle information to the management server 20 may be changed as appropriate.
The contents included in the vehicle information transmitted from the communication module 16 to the management server 20 may be changed as appropriate. For example, the vehicle information may include information other than the diagnosis data and the wired connection information.

What is claimed is:

1. An in-vehicle device that is mounted to an in-vehicle network and performs a process of collecting vehicle information from each device connected to the in-vehicle network and transmitting the vehicle information to a server, the in-vehicle device comprising a processing circuit configured to:
monitor a control area network (CAN) signal transmitted via a connector for external connection mounted to the in-vehicle network;
perform a connection determination as to whether a predetermined communication device is connected to the in-vehicle network via the connector based on a result of the monitoring of the CAN signal; and
transmit a determination result of the connection determination as included in the vehicle information to the server.

2. The in-vehicle device according to claim 1, wherein the processing circuit determines that the predetermined communication device is connected when an identifier of the predetermined communication device is detected in the connection determination.

3. The in-vehicle device according to claim 1, wherein the processing circuit determines that the predetermined communication device is not connected when an identifier of the predetermined communication device is not detected for a certain period of time in the connection determination.

4. The in-vehicle device according to claim 1, wherein the processing circuit transmits the determination result of the connection determination, as included in the vehicle information, to the server, regardless of whether a communication response to a predetermined communication request is received via the in-vehicle network or the communication response is not received.
